(19) United States
(12) Patent Application Publication
(10) Pub. No.: US 2011/0044477 A1
(43) Pub. Date: Feb. 24, 2011

(54) Quick-Coupling Wireless Microphone

(76) Inventor: Chun-Hsien HUANG, Taipei (TW)

Correspondence Address: TROXELL LAW OFFICE, PLLC, P.O. Box 1370, Annandale, VA, 22003, US

(21) Appl. No.: 12/545,835

(22) Filed: Aug. 23, 2009

(51) Int. Cl. H04R 3/00

(52) U.S. Cl. 381/122

(57) ABSTRACT

The present invention provides a microphone's quick-coupling wireless structure, which combines a wireless module with a quick-coupling switching device, whereby a wired microphone of common dimension is integrated so as to become a multi-functional quick-coupling wireless microphone; in practice, the switching device is incorporated onto the main body of the microphone by means of quick-coupling so as to form a wireless microphone; the switching device can modulate the audio signals received by original wired microphone into RF waves, which are transmitted by wireless module and received by a wireless receiver for tuning and demodulation; finally, the signals are processed with respect to the quality and volume, and then audio signals are output as a way of switching the wired microphone into a wireless one.

### BACKGROUND OF INVENTION

1. Field of the Invention

The present invention relates generally to an improved microphone, and more particularly to an innovative one which combines a wireless module with a quick-coupling switching device, whereby a wired microphone of common dimension is integrated so as to become a quick-coupling wireless microphone.

2. Description of Related Art

Referring to FIG. 1, a conventional wired microphone mainly comprises: a main body that contains an adapter (e.g. Canon adapter of conventional specification), an audio head and transmission line. With the technological progress and demanding requirements for space-saving, convenience and multiple functionality, especially for fast-growing advancement of wireless technology, many industrial initiators have introduced wireless technology into microphone, and improved it into a wireless one; with the help of a wireless receiver that permits to convert wireless signals into common audio signals, the wireless microphone has become a preferred option in the consumer market.

In general, the wired or wireless microphone is designed with an independent structure that lacks of replaceability, so the entire microphone has to be replaced without cost-effectiveness in the event of any malfunction. For the considerations above, a switching device with wireless module has been developed, which can convert easily the original wired microphone into a quick-release wireless one, presenting stronger replaceability, ease-of-operation and better economic benefits.

While there is a trend of developing the relevant products of high added-value and multiple functions, it is very necessary to propose an improved package for improving the functionality to meet the industrial requirements and also provide a technological option for the industry.

### SUMMARY OF THE INVENTION

The main objective of the present invention is to provide a quick-coupling wireless microphone, which combines a wireless module with a quick-coupling switching device, whereby a wired microphone of common dimension is integrated so as to become a multi-functional quick-coupling wireless microphone. In the practice, the switching device is incorporated into a wireless microphone by means of quick-coupling, namely, the switching device can modulate the audio signals received by original wired microphone into RF waves, which are transmitted by wireless module and received by a wireless receiver for tuning and demodulation; finally, the signals are processed with respect to the quality and volume, and then audio signals are output as a way of switching the wired microphone into a wireless one.

The features and the advantages of the present invention will be more readily understood upon a thoughtful deliberation of the following detailed description of a preferred embodiment of the present invention with reference to the accompanying drawings.

### BRIEF DESCRIPTION OF THE DRAWINGS

FIG. 1 shows an exploded view of wireless microphone of the preferred embodiment of the present invention.

FIG. 2 shows an exploded view of wireless microphone of another preferred embodiment of the present invention.

FIG. 3 shows an assembled view of wireless microphone of a preferred embodiment of the present invention.

### DETAILED DESCRIPTION OF THE INVENTION

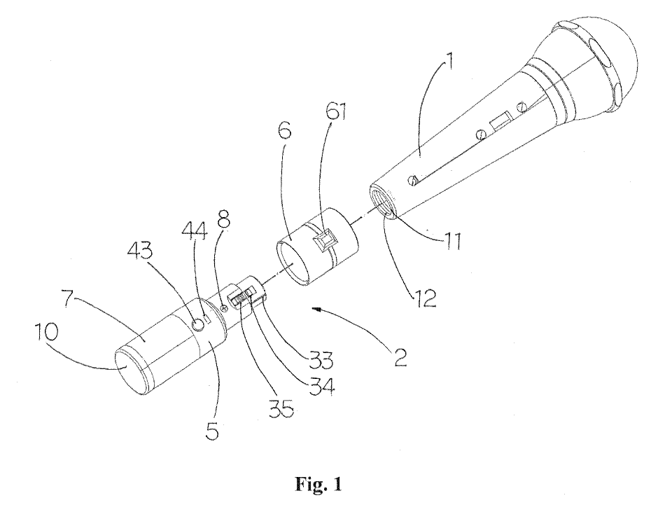

Referring to FIG. 1—an exploded view of wireless microphone of the preferred embodiment of the present invention, wherein a switching device 2 is arranged under the main body 1 of a quick-coupling wireless microphone:

a main body 1, at one end of which a cylindrical hollow chamber is arranged, and into the other end of which long groove 111 and circular trough 12 are placed for mating with the switching device 2; the main body 1 contains an audio head 13 and transmission line 14, of which audio signals are transmitted by the transmission line 14 to the switching device 2.

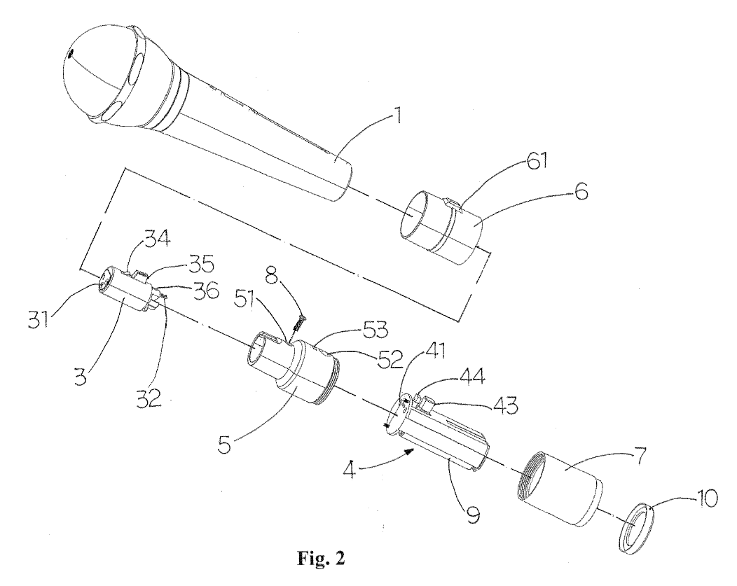

Referring to FIG. 2, the switching device 2 comprises: an adapter 3, wireless module 4, first housing 5, second housing 6 and rubber sleeve 7.

The adapter 3 is provided with a hollow cylindrical structure, at one end of which a three-hole through-hole 31 is set for penetration of the transmission line 14, at the other end of which a positive/negative terminal 32 is placed, allowing to connect and fasten the transmission line 14 and guide the audio signals into a wireless module 4; on the periphery of the adapter 3, an elongated convex guiding rod 33 and a disengagement switch 35 with a hook 34 are arranged. In practice, with the help of the guiding rod 33, the hook 34 is coupled quickly with the long groove11 and circular trough 12 within the main body 1; moreover, the hook 34 is linked by pressing the disengagement switch 35, so that the main body 1 is disengaged from the switching device 2. On the periphery of the positive/negative terminal 32, a through-hole 36 with internal thread is set for locking a screw bolt 8 into the first housing 5.

The wireless module 4 is provided with an open-ended hollow structure, at one end of which a slot 41 is placed correspondingly to the positive/negative terminal 32 of the adapter 3, enabling the audio signals to be guided into an embedded circuit board 42; the circuit board 42 of wireless transmission function can convert the guided signals and then transmit the wireless signals, which are received by a wireless receiver for wireless transmission. A battery 9 with power supply is attached onto one surface of the wireless module 4; the wireless module 4 is provided with an exposed push-key 43, and an indicator lamp 44; the push-key 43 can be used to turn on/off the wireless module 4, and the on-off state is displayed by the indicator lamp 44. The wireless module 4 is connected to the positive/negative terminal 32 of the adapter 3 via the slot 41, and placed within the first housing 5 and second housing 7.

The first housing 5 is provided with a T-shaped cylindrical structure of reducing ends, one end of which is coupled with the terminal of the main body 1, and the other end is screwed with the second housing 7; a through-hole 51 is set externally onto the first housing 5, and a screw bolt 8 is locked into the through-hole 36 of the adapter 3; in addition, through-holes 52, 53 for the push-key 43 and indicator lamp 44 of the wireless module 4 are arranged on the periphery, whilst a notch is arranged at one end for accommodating the disengagement switch 34 of the adapter 3; alternatively, through-holes 52 and 53 are combined for convenient fabrication.

The rubber sleeve 6 is provided with an elastic hollow tubular structure that's sleeved onto the joint of the adapter 3 and the first housing 5 for protection purpose; convexed key 61 is arranged on its circular surface, and located over an disengagement switch 34 of the adapter 3; the disengagement switch 34 of the adapter 3 is linked by pressing the key 61, such that the main body 1 is disengaged from the switching device 2.

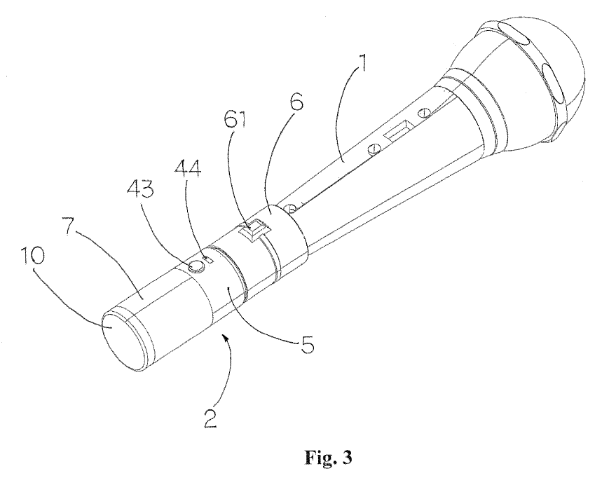

The second housing 7 is provided with a hollow tubular structure, one end of which is screwed with the first housing 5, and the other end of which is covered and sealed by a rubber bottom cap 10; the main body 1 of the wireless microphone has incorporated the first housing 5, the rubber sleeve 6, the second housing 7 and the bottom cap 10, as shown in FIG. 3. In addition, the bottom cap 10 covers the second housing 7, or the prefabricated second housing 7 is sealed for convenient fabrication.

The present invention provides a quick-coupling switching device 2 combined with wireless transmission functions, which enables quick-coupling functions since the guiding rod 33 and hook 34 of the adapter 3 are mated with the long groove11 and circular trough 12 within the main body 1; as the switching device 2 can be combined with a wired microphone of common dimension, this makes it easy to convert it into a quick-release wireless microphone featuring replaceability and multiple functions.

The switching device may, where applicable, allow replacing the wireless transmission modules in conformity with commonly used transmission modes: 2.4 GHz bandwidth, Bluetooth, IR, UHF digit, UHF linearity, VHF linearity and FM, etc, providing the users with the ease of operation and replacement.

Although the invention has been explained in relation to its preferred embodiment, it is to be understood that many other possible modifications and variations can be made without departing from the spirit and scope of the invention as hereinafter claimed.

1. A quick-coupling wireless structure of microphone, wherein a switching device is arranged under the main body of the microphone; the switching device comprising:
an adapter, at one end of which a three-hole through-hole is electrically connected with the main body, and the other end of which a positive/negative terminal is arranged; the adapter is fitted with a disengagement switch;
a wireless module, one end of which is connected with the positive/negative terminal of the adapter;
a first housing, one end of which is sleeved onto one end of the adapter;
a second housing, screwed with the other end of the first housing; and
a rubber sleeve, sleeved onto the adapter and the first housing for covering purpose.

2. The quick-coupling wireless structure of microphone as claimed in claim 1, wherein an elongated convex guiding rod and a hook are arranged on the periphery of the adapter, and the hook is linked with the disengagement switch for coordinated control.

3. The quick-coupling wireless structure of microphone as claimed in claim 2, wherein one end of the microphone's main body is provided with long groove and circular trough.

4. The quick-coupling wireless structure of microphone as claimed in claim 1, wherein convexed key is arranged on the circular surface of the rubber sleeve correspondingly to the disengagement switch.
